(19) United States
(12) Patent Application Publication
(10) Pub. No.: US 2006/0047569 A1
(43) Pub. Date: Mar. 2, 2006

(54) Voucher purchasing compliance system

(76) Inventor: Ayman A. Sulaiman, Ripon, CA (US)

Correspondence Address: Paul K. Tomita;DERGOSITS & NOAH LLP, Suite 1450, Four Embarcadero Center, San Francisco, CA, 94111, US

(21) Appl. No.: 10/930,198

(22) Filed: Aug. 31, 2004

(51) Int. Cl. G06Q 30/00

(52) U.S. Cl. 705/14

(57) ABSTRACT

The voucher purchasing compliance system checks the items being purchased to determine if the purchases are compliant with the voucher program requirements. The system identifies the customer and the customer's status within the voucher program, that the status of the voucher is within the 30-day usability time period, and determines which items and quantities of these items that are compliant with the voucher program rules. Each of the items being purchased is compared to the authorized items and authorized quantities of items to determine if the purchase is compliant with the voucher program. If an item is not compliant with the voucher program rules, the system provides an error signal indicating that the purchase is not authorized and the purchase is corrected.

### BACKGROUND

Various government and privately funded programs provide vouchers to certain individuals which can be used to purchase specific items at stores. These programs typically regulate the items that can be purchased with the vouchers. For example, in a nutritional supplement program the items approved for purchase can be limited to foods that have a certain nutritional value. The voucher program may regulate the types of foods that can be purchased, as well as the quantities of each food item that may be purchased depending upon the status of the voucher recipients. In determining the status of the voucher recipient various factors are considered including: age, gender and physical condition. The program may allow the voucher recipient to purchase specific types and quantities of consumable items based upon the person's status.

An example of a government subsidized food voucher program is the WIC (Women, Infants and Children) program. The WIC program provides vouchers which can be used at certain grocery stores to buy milk, cheese, eggs, juice, cereals, beans, peanut butter, baby formula and various other consumable items to certain women and children. The quantities of each authorized food item which may be purchased is regulated based upon the status of the individual. For example, a pregnant woman will have different dietary needs than an infant and therefore the items authorized for purchase under the WIC program vary for each different type of individual. Under the WIC program each type of individual falls within a specific status based upon physical condition and age.

A problem with these programs is the difficulty in checking the program compliance of the food products and quantities of food products that are being purchased by the voucher holders. Some of the voucher programs have put the responsibility of program compliance upon the store participating in the voucher program. If a store allow a voucher recipient to purchase unauthorized food items or improper quantities of an authorized food item, the store can be sanctioned for these violations by the voucher program administrators. These sanctions can be costly and may in some cases even result in the store being removed from the voucher program.

Compliance with the voucher program rules may be a great burden upon the stores because the program rules information may only be provided on paper documents. In order for the store to insure that each voucher purchase is compliant with the voucher program rules, a store employee must check specific information. The cashier must identify the purchaser, determine the status of the customer and then check each item being purchased to determine compliance with the information on the voucher as well as the program rules. If there are errors in the items being purchased with the vouchers, the employee must make the necessary corrections. Because the voucher program requirements can be very complex, it would be very easy for an employee to make an error which would result in the store to be penalized for not complying with the program rules. What is needed is an automated system for checking the voucher purchase for compliance with the program rules.

### SUMMARY OF THE INVENTION

The inventive system uses a computer program to check the compliance of the purchases with voucher subsidy programs such as the WIC (Women, Infants and Children), food stamps or any other non-cash program that has specific purchasing requirements. The WIC program provides women, infants and children with vouchers which can be used to purchase consumable items, primarily food which is intended to support the health of the individuals. The present invention is a computerized purchasing system which determines the compliance of purchases of goods made to insure that they meet the requirements of the voucher program.

The inventive system users a computer program to check all voucher purchases. The inventive system stores the program rules in a “rules database” and the customer information in a “customer database.” The network is also connected to the cash registers of the stores where the voucher purchases are made. A plurality of cash register computers may be networked to a server computer that includes a rules database and a customer database. When the rules of the voucher program are modified, the information is input into the rules database and shared with all networked cash registers. Because the cash registers are networked, they can all share customer information.

The system may also track the changing status of each program member based upon changes in physical condition as well as the age of the program members. The physical changes resulting in a change in status can include: pregnancy, breastfeeding, birth and death. These physical changes can be input manually or electronically to accurately maintain the status information of the program members. The status of the WIC member may also change based upon the passage of time. For example, program members less than one year of age have the status of “infant” and will be issued baby formula for one year. Program members between the ages of one and five years old have the status of “child” and will not receive baby formula. In an embodiment, the inventive system can automatically update the status of the program members based upon the passage of time. When a program member is born, the system keeps the baby's status as an infant for one year and then automatically changes the status from infant to child after the first birthday.

When purchases are made with vouchers, the program member brings the items to the store's register and a cashier checks the program member's identification information. This identification information may require the presentation of a WIC Authorization Folder which includes the participant, parent or guardian signature as well as alternate signatures. If the identification complies with the program requirements, the cashier inputs the identification of the customer into the inventive system. The system obtains the customer information stored on the customer database which may include the status of the customer and any other individuals associated with the customer.

After the program identification has been passed, the cashier can then begin purchasing items using the voucher program checks. Based upon the customer information, the system determines if the items and quantities of the items being purchased comply with the requirements printed on the voucher or the rules of the voucher program. The cashier inputs the items being purchased into the inventive system by scanning the item's bar code. If there is a compliance violation, the system warns the cashier that the purchase does not comply with the WIC rules. Because the vouchers cannot be used to purchase the item the cashier must either correct or cancel the purchase. The inventive system then records the items purchased and updates the customer's records in the customer database. This process continues until all items are checked.

The cashier must also check various other compliance requirements printed on the voucher including: the name of the grocery store on the check, the dates that the check is valid, the items that may be pursed, the quantity of the items that may be purchased and the maximum value. After the purchase is made the customer information is updated to identify the items purchased by the program member as well as the time, date and location of the purchase. If the purchases comply with the voucher program rules, the store can deposit the voucher checks to obtain money from the voucher program. The system displays the amount of money spent on the voucher program items and prints this price onto the voucher program check the Program endorses the vouchers. The program member signs the voucher so that the voucher can be deposited like a check.

In an embodiment, the inventive system is networked to a number of computers located at multiple cash registers in a plurality of stores. Each computer has access to the rules and customer databases. When a voucher purchase is made, the customer's records are updated. By sharing the information, the customer can use various stores to make the voucher purchases and the system will accurately track each purchase for program compliance.

In an embodiment, the inventive system is able to check the compliance of multiple voucher programs simultaneously. In this configuration, the system has multiple databases containing rules for multiple voucher programs. When a customer makes a voucher purchase, the system determines which voucher program is being used and accesses the rules and customer information associated with the voucher program used to purchase the items. Once the voucher program is determined, the system can perform the voucher program compliance as described.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention is herein described, by way of example only, with reference to embodiments of the present invention illustrated in the accompanying drawings, wherein:

FIG. 1 is a diagram illustrating the networking of the server computer with branch computers;

FIG. 2 is a flowchart of the process steps used to check the compliance of purchases with a program's rules; and

FIG. 3 is a flow chart of the process steps used to determine the status of the program members.

### DETAILED DESCRIPTION

The inventive system program is used to monitor the compliance of all vouchers purchases to check compliance with the voucher program rules. Although the inventive system is compatible with various voucher purchase programs, all examples of the inventive system will be described as they are applied to the WIC (women, infants and children) voucher program.

The WIC program has specific procedures that must be followed. WIC provides stores with a WIC Authorized Food List (WAFL) which contains a complete list of foods that the program participants can purchase using WIC vouchers. All WIC program members receive a WIC Authorization Folder which must be presented to the cashier when the WIC member makes a purchase using WIC vouchers. The WIC Authorization Folder includes the signatures of the WIC program member as well as alternative signatures. The WIC member also receives WIC vouchers which includes specific information including: the WIC member's Individual Number, the name of the member, the first date of use, the last day of use, the check serial number, the name of the store where the purchase is made, the items which may be purchased, the quantity of the items that may be purchased, the maximum cash value that may be purchased, a space the exact purchase price, a signature line and notification that the check must be deposited within 45 days of the “first day of use” date. In order to use the WIC checks, the purchase must comply with each of the requirements listed above. Each piece of information on the WIC voucher is verified by the cashier of the store. The inventive system assists in the processing of WIC check purchases.

The inventive program includes a rules databases, a customer databases connected to a server computer and also networked to multiple client computers located at cash registers in the WIC stores. The rules database includes data which indicates the WIC program requirements and includes a listing of items which are approved for WIC voucher purchase and purchasing rules associated with the different categories (status) of customers. The customer database includes: WIC program member information, status information for each WIC program member, and prior purchase records for the WIC program member. Other databases may also be connected to the server computer and may include information regarding the inventory of WIC approved items for each store and WIC purchases made under at each cash register of each store.

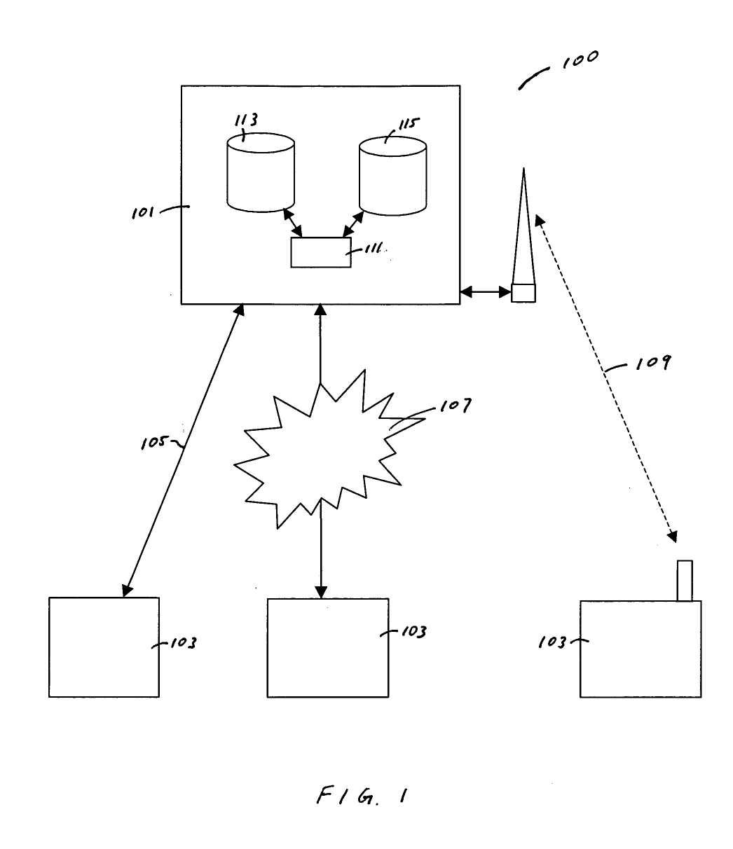

The basic configuration of the system components may be better understood with reference to FIG. 1. The inventive system 100 uses a server computer 101 that has a microprocessor 111, a rules database 113 and a customer database 115. Before using the inventive system 100, the rules of the voucher program must be input into the rules database 113. If the program rules change, the data in the rules database 113 can be updated so that the inventive system is always able to check the compliance with the most current WIC information. The rules database modifications typically involve information that is forwarded to the merchant by the WIC program administrators and the WIC program members generally provide information used to modify the member database. Data including the status for each of the voucher program members must be input into a customer database 115 typically when the member first joins the voucher program. As the status of the members change, the data in the member database must also be modified to insure compliance with the voucher program. Both the rules database 113 and the customer database 115 can be modified manually or automatically. The manual modifications are input into the server computer 101 typically through a keyboard. Automatic modification is based upon an algorithm running in the software of the inventive system which tracks the change in time and automatically updates the status of the WIC program members based upon time and age.

The server computer 101 is networked to client computers 103 integrated into or located near the merchant's cash registers. The communications between the server computer 101 and the client computers 103 is through a network which may include: a wired local area network 105, the internet 107, a wireless network 109 or any other network configuration. The server computer 101 communicate with the client computers 103 through the network(s). Within a merchant's store, at least some of the system's client computers 103 are placed at the checkout counters or in communication with the checkout counter. The store's customers can then make purchases with the WIC vouchers through the cashiers having access to the networked computers. If the network extends to other stores, each client computer 103 has access to the rules database 113 and customer database 115. By networking the inventive system, the WIC merchants can verify the compliance of voucher purchases made at a variety of stores rather than only one store.

WIC requires that the identification of the WIC member be checked against the WIC member folder which must be done by the cashier. However, without a computerized system, the WIC store employees must also manually check various other information such as the status and past purchases of the WIC customers to determine the compliance of the customer purchases. This checking can be very tedious if the rules and customer information are only written on paper. Also because paper copies of information are not easily shared with other stores, the customer may be required to shop at a single store in order to maintain accurate purchasing records.

In contrast, the inventive computerized and networked purchasing compliance system has significant advantages. The inventive system accesses the records and automatically modifies the customers records at various store locations instantaneously. The network also allows the purchasing information for each person to be shared amongst all other networked computers and stores. Thus, the purchaser can use different stores to make WIC purchases and each store will share the purchase information associated with the customer from all other networked computers.

In order to receive vouchers from the WIC program, one or more individuals within a family must meet the status requirements of the WIC program. The status of women supported by the WIC program is determined by her physical condition, whether she is breastfeeding and the duration of time after the pregnancy has ended. The status of the children is determined by age. Table 1 lists the different status of individuals supported by the WIC program.

TABLE 1

| Status | Requirements |
|---|---|
| Pregnant Women | Women who are pregnant or up to 6 weeks |
| | after birth or after pregnancy ends |
| Breastfeeding Women | Women who have given birth and are |
| | breastfeeding an infant less than 1 year old. |
| Nonbreastfeeding | Women who were pregnant and not breastfeeding, |
| Postpartum Women | up to 6 months after the pregnancy ends |
| Infants | Babies up to 1 year in age |
| Children | Babies up to their 5 years in age |

The status of the women, infants and children will all change over time. For example, a customer may enter the WIC program with a “pregnant” status. After the child is born, the woman remains in the “pregnant” status for another 6 weeks, but the mother now also has an “infant” who is also a WIC program member. Six weeks after birth the woman's status changes to either “nonbreastfeeding” or “breastfeeding.” If the mother does not breastfeed, she remains in the non-breastfeeding status for up to 6 months. Alternatively, if the mother does breastfeed she will have the breastfeeding status for 1 year. After one year of breastfeeding, the mother looses her status entirely and is no longer part of the WIC program. However, for one year after birth the baby remains in the WIC program under the status of “children.” The child can continue to receive support through WIC until he or she reaches the age of 5. In some of these cases the inventive system automatically inputs the changes to the customer status by tracking the passage of time.

The WIC program provide vouchers based upon the status of the WIC members. More specifically, the status of the WIC program member is used to control the types of items which may be purchased with the vouchers so that the subsidy will provide the correct nutritional supplement to the WIC member. For example, the WIC program allows baby formula to be purchased for infants but not women. Thus, a pregnant woman who was not caring for a baby in the WIC program cannot purchase baby formula using the WIC vouchers. Similarly, a mother who is only given WIC vouchers for a child cannot use these vouchers to purchase an adult cereal that is not suitable for children. Because the various food items are not suitable for all WIC members, the system restricts the type of cereal that may be purchased with vouchers based upon the status of the customer as well as the status of the dependents of the customer.

The basic process of purchasing items can vary depending upon the WIC members, however an example of how the inventive system works is described below. In this example, a pregnant woman receives the WIC vouchers to purchase consumable items for herself as well as any of her children under the age of five. The woman goes to a WIC store, gathers various items and brings the items to the store's cash register to make the voucher purchase. The cashier check's the WIC identification and inputs the customer's identification into the inventive system. Although the customer's identity can be determined through various possible means, the WIC regulations currently require the customer to show the cashier a WIC Authorization Folder which includes a “WIC Program Authorization Card.” The WIC Authorization Folder contains the WIC member's name as well as the names of alternate shoppers who can purchase WIC items for the WIC member.

The cashier then enters this information, the name or ID code of the customer into the computer. After presenting the WIC identification, the WIC member can spend WIC vouchers. The WIC vouchers are printed with specific information such as: the WIC member code associated with the voucher, the name of the WIC member, the store that the purchase may be made, the items may be purchased, the quantity of item that may be purchased and the dates between which the voucher may be used, the serial number of the voucher, the maximum cash value of the voucher. For Example, a WIC voucher may be for Nutritional Care Sales stores and specify that the first day of use is Aug. 11, 2004 and the last day of use is Sep. 10, 2004. The WIC voucher may specify that any of the following items may be purchased: pasteurized milk in gallon containers up to 2 gallons, 12 oz to 2 lbs. of cheddar, jack, American or mozzarella cheese or up to 2 dozen AA white eggs (small, medium or large). Finally, the voucher may specify that the price of these items must not exceed $20.02.

The cashier must check each voucher to be sure that the purchase complies with the requirements printed on the voucher. Because there are many conditions placed upon the members using the vouchers, the inventive system may include a scanner. The voucher is placed in the scanner which is capable of recognizing the data printed on the voucher. The scanner reads the data from the voucher and forwards the voucher data to the computer. The WIC voucher can also be manually input into the system through a keypad, a magnetic strip reader or any other suitable data input device. The system then automatically checks the compliance of the items being purchased so the voucher can only be used within the valid dates. The items and quantities being purchased are authorized by the voucher. The cost of the items being purchased does not exceed the maximum value printed on the voucher. The system can also prevent the sale of alcoholic beverages, tobacco products, firearms, ammunition, explosives or controlled substances in exchange for WIC checks. If any of these WIC rule violating transactions are attempted, the inventive system can automatically prevent the sale. After the voucher purchases are made, the transactions are automatically recorded electronically and the purchasing history of each WIC member is automatically stored on the WIC member database. The WIC rules currently require that WIC purchasing information be maintained for at least three years.

Although, the voucher data includes most information needed to determine if the voucher purchase is authorized, there is additional information that can be checked to further insure compliance with the WIC program rules. The WIC program produces listings of items which are authorized for purchase with the WIC vouchers. These listings vary depending upon the status of the WIC member and are stored in the rules database. For example, the WIC program authorizes the purchase of breakfast cereals for adult voucher recipients, but does not authorize the purchase of this same item for infants. Thus, a pregnant woman would be able to purchase this cereal with WIC vouchers. One year after the child is born when the mother is no longer part of the WIC program, the mother would still receive vouchers for her one year old child. However, the mother would not be able to purchase items such as adult cereal with the child's vouchers. The vouchers assigned to the child can be used to purchase a child formulated cereal but cannot be used to purchase the adult cereal. Based upon the status of the voucher recipients the inventive system determines which items may be purchased with the WIC vouchers.

When the items being purchased with the WIC vouchers are scanned by the cashier, the inventive system can automatically determines the status of the WIC member and if the item is on the list of items authorized by the WIC rules. The WIC rules may also include additional information about the authorized items, authorized quantities of the items and authorized brands for each item. If the scanned items being purchased do not meet these WIC rule requirements, the system informs the cashier of the error so the transaction can be stopped or corrected. Thus, the task of checking the compliance of the items being purchased with WIC vouchers is aided by the inventive system.

It is contemplated that various improvements and updates can be made to adjust the inventive system so that it will meet the changing WIC program requirements. If the WIC regulations change to allow different identification verification methods, various alternative processes may be used. For example, the customer identification or voucher information may be encoded with a bar code, a magnetic strip or any other encoding or printing method. Any other lawful identification method may also be used including: biometrics, finger print scanning, retina scanning, photo match analysis, signature recognition, voice recognition, etc. These improvements can be implemented as the WIC regulations change to accept these methods. The inventive system uses a computer program that interfaces with a merchant's cashiers through a graphical user interface. The computer may have various input and output devices such as: mouse, keyboard, bar code, magnetic strip reader, RF ID tag, visual indicator, screen, touchpad, video camera (machine vision), microphone (voice recognition), touch screen, audio speaker or any other compatible computer input/output device(s). The inventive system checks vouchers purchases to insure that each item is in compliance with the rules of the voucher program. For simplicity, the inventive system will be described as it is used with the WIC nutritional supplement program. It is contemplated that the inventive system is also capable of checking the compliance with any other non-cash purchase programs.

The inventive system uses the WIC member's identification to obtain all information for the WIC member as well as any information of any dependents of the WIC member. The customer information includes the status of the customer and the status of any children under the customer's care. The customer information may also includes all previous voucher purchases made by the customer during the past three or more years. With the customer's information, the inventive system can determine if the items being purchased by the customer are authorized for purchase by the WIC program rules.

If the voucher purchase is fully compliant with the WIC rules and requirements, the system may inform the cashier that the purchase is authorized. The WIC member or guardian then signs the voucher to complete the purchase transaction. The store is able to deposit the voucher like a check and the inventive voucher purchase system updates to the member information in the member database with this purchase information. The revised customer information can then be accessed and revised when the next purchase is made by the customer.

Although the process has been described in a specific sequence, it is contemplated that the inventive system can perform the voucher purchase confirmation through various other process steps and methods. For example, the inventive system may update the customer records after all the items have been checked for compliance rather than after each item is checked. Similarly, the WIC rules and/or customer information may be downloaded and stored on one or more branch computers so that a central rules database is not accessed each time a WIC purchase is checked.

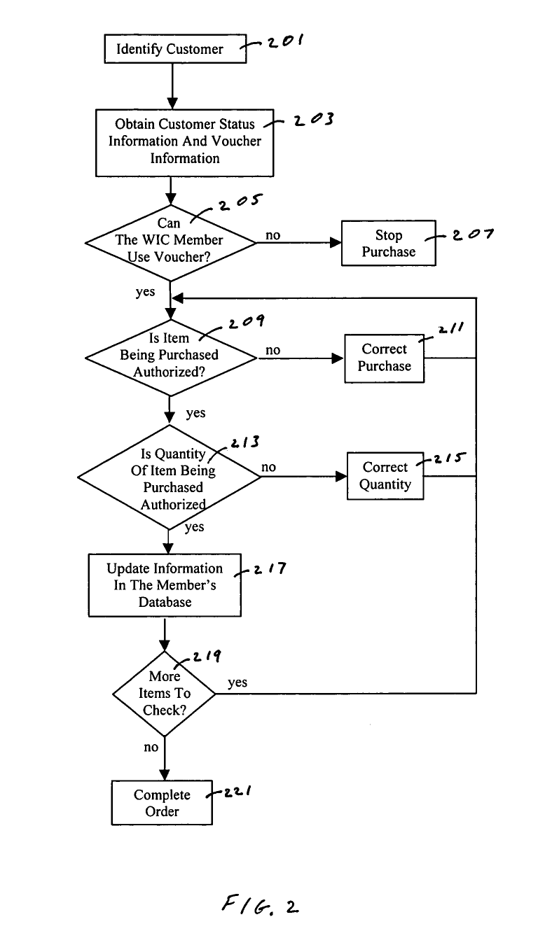

This process for voucher purchases and compliance checking is illustrated in a flow chart form in FIG. 2. When the WIC member is making a voucher purchase, she must identify herself to the cashier 201. The customer provides the WIC voucher and the cashier then inputs a customer identification code as well as information printed on the voucher 203. Certain information in the voucher is checked to determine if the voucher can be used by the customer 205. These requirements includes: the date of purchase, the store specified on the voucher and the name of the WIC member on the voucher. It may also be possible for the WIC program to cancel the check and notify the store that certain voucher serial numbers are void. If any of these conditions exist which prevent the use of the voucher, the transaction is stopped 207.

If the initial voucher purchase conditions are satisfied, the items being purchased are checked against the WIC rules 209. The cashier scans the items being purchased with the WIC vouchers and the items being purchased are compared to the description of items on the voucher as well as the listing of items authorized for purchase by the WIC rules. The items being purchased must meet the description, brand and cost. If the item being purchased is not authorized, the cashier must stop or correct the transaction 211. If the item is authorized, the quantity, weight or volume of the item being purchased against the voucher and the rules of the WIC program 213. Again if the quantity is not authorized, the cashier must stop or correct the transaction 215. If the quantity is authorized, the cashier writes in the cost of the items and the customer signs the voucher. With the voucher purchase complete, the purchase information is input into the customer's records in the customer database 217. If the customer has more WIC vouchers the process is repeated 219. Once all WIC vouchers have been checked the order is complete 221.

As discussed, the status of the WIC member depends upon various factors including age and physical condition. When a person applies for WIC assistance, a specific process may be required to determine the status of the voucher recipients. With reference to FIG. 3, when a woman joins the WIC program, specific information is input into the inventive system to determine the status of the woman and her dependents 301. The system asks if the woman is pregnant or has given birth within the last 6 months 303. If the woman meets either of these conditions, she will have the status of pregnant 305. If the woman is not pregnant, the system asks if the woman is post partum and breastfeeding a child that is less than 1 year old 307. If so, the woman has a status of breastfeeding 309. If the woman is neither pregnant nor post partum and breastfeeding a child less than 1 year old, the system asks if the woman is post partum and has a child less than 6 months old 311. If so, the woman has a status of non-breastfeeding post partum 313. If the woman does not meet the requirements of the pregnant, post partum/breastfeeding or post partum/non-breastfeeding, she will not receive vouchers for herself.

Even though the woman will not receive vouchers for herself, she may be able to receive WIC vouchers for her children. The system asks if the woman has any children less than 1 year old 315. If so, the system asks for the number of children under 1 and assigns each the status of infant 317. The system then asks if the woman has any dependents under the age of 5 years old 319. If so, the system asks for the number of children under 5 and assigns each the status of child 321. The status of each child is associated with the woman 323 so that that she receives vouchers for herself as well as any of her children who are supported by the WIC program.

As illustrated above, the status of the WIC members will always change over a period of time. It is possible to manually check the status of the mother and her children each time voucher purchases are made, however this is very time consuming and inefficient. In an embodiment, the inventive system automatically updates the status of the woman and her children to update the status of the woman and children. For example, information such as the date of pregnancy, the date of birth or the date the pregnancy ends may be input into the system. Other relevant information is also input into the system including: multiple births, adoptions and dates of deaths. With this information, the system may automatically update the status of the woman based upon the time that has elapsed after birth or after the pregnancy ends. With this information, the system automatically tracks the changes in status of the woman from pregnant to post partum and finally determines when the woman exits the WIC program. The system can also automatically track the child's status change from infant to child and the child's fifth birthday after which the child exits the WIC program. By automatically tracking the change in status, the customer information is accurately maintained and errors in the WIC purchases can be further minimized.

In an embodiment, the inventive system is also compatible with inventory programs that monitor inventory levels and determine when additional goods need to be purchased. All inventory items are monitored by the system and the system can track the rate of consumption for various items. By knowing the normal rate at which inventory items are purchased, the future purchases for the items can be planned and the store can buy the expected quantity of the goods that are needed. In addition to projecting sales of goods, the inventive system may also warn the store when inventories are running low for a WIC inventory item. The low inventory warning may be set based upon the normal consumption rate. For example, the system may be configured to notify when there is one week's supply of an item left in inventory. This feature can prevent the store from being sanctioned for stocking an insufficient quantity of a WIC item.

Because the system utilizes a network such as the internet, the inventive system may monitor the transactions of the stores as well as the inventory levels remotely. Any computer connected to the network or internet can access the inventive system after passing through a security system. For example, access to the system may be allowed once the user has input an authorized user name and a personal identification number. The system may also utilize a fire wall which protects the computers in the network from unauthorized access by hackers.

In another embodiment, the inventive system may be able to process multiple voucher programs simultaneously. For example, the inventive system may be used to check the purchases made with both WIC vouchers and food stamps simultaneously. In this embodiment, an additional rules databases is installed for each additional voucher program. During the purchase of the items, the customer would inform the cashier which voucher program is being used. The inventive system then accesses the rules and customer information for the voucher program being used and the checking of the items being purchased will proceed as described above.

The inventive system may also be able to detect any fraudulent use of the vouchers. Because the system accesses all voucher purchases made by individuals, it is also capable of determining the specific quantities of vouchers used by a WIC customer. If a customer improperly acquires additional vouchers, the system is able to detect that the customer has spent more vouchers than she has received and therefore may indicate fraudulent use of WIC vouchers. Similarly, if the vouchers each have identification numbers such as serial numbers, the system can detect the serial numbers and can determine if the vouchers are assigned to the customer making the purchase.

Eventually, the inventive system may be able to eliminate the need for the vouchers entirely because the customer's records will contain all the voucher information. In this embodiment, the voucher credits will automatically be credited to the customer. The WIC program may notify the member of the voucher credit electronically. Without using physical vouchers, the inventive system will perform all accounting required to keep track of the customer's the voucher transactions. This embodiment is useful because it eliminates the risk of loosing the vouchers or improperly using the vouchers. For example, without physical vouchers, they cannot be traded for money.

In the foregoing, a program compliance system has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method for determining compliance with a voucher program comprising the steps:
providing a first computer having access to a voucher rules database which stores purchasing rules for a voucher program;
identifying an item being purchased by a customer;
determining if the item being purchased is authorized by the purchasing rules of the voucher program; and
displaying an error signal if the item being purchased is not authorized by the purchasing rules of the voucher program.

2. The method for determining compliance with a purchasing program of claim 1 further comprising the steps:
providing a customer database which is accessible to the first computer;
inputting an identification code for a customer; and
accessing the customer database to obtain the status of the status of the customer;
wherein the determining step includes comparing the item being purchased to the items authorized for purchase by the purchasing rules of the voucher program for the status of the customer.

3. The method for determining compliance with a purchasing program of claim 2 further comprising the step:
identifying the status of a voucher program member associated with the customer;
wherein the determining step includes comparing the item being purchased to the items authorized for purchase by the purchasing rules of the voucher program for the status of the voucher program member associated with the customer.

4. The method for determining compliance with a purchasing program of claim 2 further comprising:
a server computer connected to the voucher rules data base and the customer database;
wherein the server computer updates records stored in the customer database for the customer based upon the item being purchased.

5. The method for determining compliance with a purchasing program of claim 4 wherein the server computer updates the status of the customer based upon the passage of time.

6. The method for determining compliance with a purchasing program of claim 3 wherein the server computer updates the status of the voucher program member associated with the customer based upon the passage of time.

7. The method for determining compliance with a purchasing program of claim 1 further comprising the step:
inputting data from a voucher into the first computer;
wherein the determining step includes comparing the data printed on the voucher to the item being purchased.

8. A voucher purchasing system comprising:
a first input device for inputting the identification of a customer;
a second input device for inputting the identification of an item being purchased;
a computer connected to the first input device and the second input device, the computer having access to a voucher rules database and a customer information database;
a computer program which obtains status information for the customer from the customer database and compares an item being purchased with a listing of items authorized for purchase based upon the status of the customer; and
an output device which indicates if the item being purchased is not authorized for purchase because it is not on the listing of items authorized for purchase.

9. The voucher purchasing system of claim 8 further comprising:
an input device for inputting data from a voucher into the first computer;
wherein the determining step includes comparing the data printed on the voucher to the item being purchased.

10. The voucher purchasing system of claim 9 wherein the input device is an optical scanner which scans the surface of the voucher and forwards voucher data to the computer program and wherein the computer program compares the item being purchased with the voucher data to determine if the item complies with the voucher data and the output device indicates if the item being purchased does not comply with the voucher data.

11. The voucher purchasing system of claim 8 further comprising:
a third input device for inputting data from a voucher;
wherein the computer program running on the computer compares the data from the voucher to the item being purchased and determines if the item being purchased complies with the data from the voucher.

12. The voucher purchasing system of claim 8, wherein data representing the item being purchased in input into the customer database if the item being purchased is authorized for purchase by the computer program.

13. The voucher purchasing system of claim 8, further comprising:
a network which provides a plurality of computer with access to the voucher rules database and the customer information database.

14. A voucher purchasing system comprising:
a first input device for inputting data from a voucher;
a second input device for inputting the identity of an item being purchased;
a computer connected to the first input device and the second input device having access to a voucher rules database;
a computer program running on the computer that compares the data from the voucher to the item being purchased; and
an output device which indicates if the item being purchased does not comply with the requirements of the voucher.

15. The voucher purchasing system of claim 14 further comprising:
a customer database accessible by the computer;
wherein if the item being purchased complies with the requirements of the voucher, the computer program stores data representing the item being purchased in the customer database.

16. The voucher purchasing system of claim 14 further comprising:
a network which provides a plurality of computer with access to the voucher rules database and the customer information database.

17. The voucher purchasing system of claim 14 further comprising:
a third input device connected to the computer for inputting the identification of a customer;
wherein the computer program determines the status of the customer and compares the item being purchased to a listing of items authorized for purchase based upon the status of the customer.

18. The voucher purchasing system of claim 14, wherein data representing the item being purchased in input into the customer database if the item being purchased is authorized for purchase by the computer program.

19. The voucher purchasing system of claim 14, wherein the input device is an optical scanner which scans the surface of the voucher and forwards voucher data to the computer program.

20. The voucher purchasing system of claim 14, wherein data representing the item being purchased in input into the customer database if the item being purchased is authorized for purchase by the computer program.
